(19) United States
(12) Patent Application Publication
(10) Pub. No.: US 2025/0071785 A1
(43) Pub. Date: Feb. 27, 2025

(54) CARRIER CONFIGURATION METHOD AND APPARATUS, AND TERMINAL DEVICE

(71) Applicant: GUANGDONG OPPO MOBILE TELECOMMUNICATIONS CORP., LTD., Dongguan (CN)

(72) Inventors: Bingxue LENG, Dongguan (CN); Qianxi LU, Dongguan (CN)

(21) Appl. No.: 18/945,865

(22) Filed: Nov. 13, 2024

Related U.S. Application Data
(63) Continuation of application No. PCT/CN2022/110360, filed on Aug. 4, 2022.

(51) Int. Cl. H04W 72/40; H04W 72/0453; H04W 72/51

(52) U.S. Cl. CPC H04W 72/40; H04W 72/0453; H04W 72/51

(57) ABSTRACT

Provided are carrier configuration methods and apparatuses, and terminal devices. The method includes that: a first terminal device sends first information to a second terminal device, the first information being used for the second terminal device or a second network where the second terminal device is located to configure carriers; and the first terminal device receives first configuration information from the second terminal device, the first configuration information being used for configuring a plurality of carriers, and at least some of the plurality of carriers being used for performing unicast sidelink communication between the first terminal device and the second terminal device.

### CROSS-REFERENCE TO RELATED APPLICATION

This application is a continuation application of International Patent Application No. PCT/CN2022/110360 filed on Aug. 4, 2022, the entire contents of which are incorporated herein by reference.

### TECHNICAL FIELD

Embodiments of the disclosure relate to the technical field of mobile communication, in particular to a method and apparatus for carrier configuration and a terminal device.

### BACKGROUND

In SideLink (SL) communication, not only communication in broadcast mode, but also communication in unicast mode and multicast mode can be supported. For sidelink communication in unicast mode (hereinafter referred to as unicast sidelink communication), there is only one terminal device corresponding to the receiving end of the communication. In order to expand bandwidth, introduction of carrier aggregation technology into sidelink communication is considered, and support for carrier aggregation in unicast sidelink communication needs to be improved.

### SUMMARY

Embodiments of the disclosure provide a method and apparatus for carrier configuration, a terminal device, a chip, a computer readable storage medium, a computer program product, and a computer program.

There is provided a method for carrier configuration in an embodiment of the disclosure, the method includes the following operations.

A first terminal device transmits first information to a second terminal device. The first information is used for the second terminal device or a second network where the second terminal device is located to configure carriers.

The first terminal device receives first configuration information from the second terminal device. The first configuration information is used to configure a plurality of carriers, and at least part of the plurality of carriers is used for unicast sidelink communication between the first terminal device and the second terminal device.

There is provided a method for carrier configuration in an embodiment of the disclosure, the method includes the following operations.

A second terminal device receives first information from a first terminal device. The first information is used for the second terminal device or a second network where the second terminal device is located to configure carriers.

The second terminal device transmits first configuration information to the first terminal device. The first configuration information is used to configure a plurality of carriers, and at least part of the plurality of carriers is used for unicast sidelink communication between the first terminal device and the second terminal device.

There is provided an apparatus for carrier configuration in an embodiment of the disclosure. The apparatus is applied to a first terminal device, and includes a transmission unit and a reception unit.

The transmission unit is configured to transmit first information to a second terminal device. The first information is used for the second terminal device or a second network where the second terminal device is located to configure carriers.

The reception unit is configured to receive first configuration information from the second terminal device. The first configuration information is used to configure a plurality of carriers, and at least part of the plurality of carriers is used for unicast sidelink communication between the first terminal device and the second terminal device.

There is provided an apparatus for carrier configuration in an embodiment of the disclosure. The apparatus is applied to a second terminal device, and includes a transmission unit and a reception unit.

The reception unit is configured to receive first information from a first terminal device. The first information is used for the second terminal device or a second network where the second terminal device is located to configure carriers.

The transmission unit is configured to transmit first configuration information to the first terminal device. The first configuration information is used to configure a plurality of carriers, and at least part of the plurality of carriers is used for unicast sidelink communication between the first terminal device and the second terminal device.

There is provided a terminal device in an embodiment of the disclosure, the terminal device including a processor and a memory. The memory is configured to store a computer program, and the processor is configured to invoke and execute the computer program stored in the memory to implement the method for carrier configuration described above.

There is provided a chip in an embodiment of the disclosure, the chip being configured to implement the method for carrier configuration described above.

Specifically, the chip includes a processor for invoking and executing a computer program from a memory such that an apparatus mounted with the chip implements the method for carrier configuration described above.

There is provided a computer-readable storage medium in an embodiment of the disclosure. The computer-readable storage medium has stored thereon a computer program that, when executed by a computer, causes the computer to implement the method for carrier configuration described above.

There is provided a computer program product in an embodiment of the disclosure. The computer program product has stored therein computer program instructions that, when executed by a computer, cause the computer to implement the method for carrier configuration described above.

There is provided a computer program in an embodiment of the disclosure. The computer program, when executed by a computer, causes the computer to implement the method for carrier configuration described above.

With the technical solutions described above, the first terminal device provides the first information to the second terminal device to assist the second terminal device or the second network where the second terminal device is located in configuring multiple carriers for unicast sidelink communication between the first terminal device and the second terminal device, thereby supporting carrier aggregation in the unicast sidelink communication. Such a carrier configuration method, by incorporating the first information provided by the first terminal device as assistance, results in configured carriers with higher reliability, thereby enhancing the performance of the unicast sidelink communication.

### BRIEF DESCRIPTION OF THE DRAWINGS

The accompanying drawings illustrated herein are intended to provide a further understanding of the disclosure and form part of the disclosure. The schematic embodiments of the disclosure and their description are intended to explain the disclosure, and do not constitute an unduly limiting of the disclosure. In the accompanying drawings:

FIG. 1A is a schematic diagram of a terminal device in Mode 1.

FIG. 1B is a schematic diagram of a terminal device in Mode 2.

FIG. 2 is a first schematic flowchart of a method for carrier configuration provided in an embodiment of the disclosure.

FIG. 3 is a second schematic flowchart of a method for carrier configuration provided in an embodiment of the disclosure.

FIG. 4 is a third schematic flowchart of a method for carrier configuration provided in an embodiment of the disclosure.

FIG. 5 is a first schematic diagram of a compositional structure of an apparatus for carrier configuration provided in an embodiment of the disclosure.

FIG. 6 is a second schematic diagram of a compositional structure of an apparatus for carrier configuration provided in an embodiment of the disclosure.

FIG. 7 is a schematic structural diagram of a communication device provided in an embodiment of the disclosure.

FIG. 8 is a schematic structural diagram of a chip in an embodiment of the disclosure.

FIG. 9 is a schematic block diagram of a communication system provided in an embodiment of the disclosure.

### DETAILED DESCRIPTION

The technical solutions in embodiments of the disclosure will be described below with reference to the accompanying drawings in embodiments of the disclosure. It is apparent that the embodiments described herein are only part of but not all of embodiments in the disclosure. Based on the embodiments in the disclosure, all other embodiments obtained by those of ordinary skilled in the art without any creative effort are within the scope of protection of the disclosure.

For convenience of understanding of technical solutions in embodiments of the disclosure, the related technologies of embodiments of the disclosure will be illustrated below. The following related technologies, as an alternative, can be arbitrarily combined with the technical solutions in embodiments of the disclosure, and they are all within the scope of protection of embodiments of the disclosure.

### Device to Device (D2D) Communication

D2D communication technology has been introduced in a Long Term Evolution (LTE) system. D2D communication is based on sidelink transmission technology. Different from a traditional cellular system in which communication data is received or transmitted by a base station, an Internet of Vehicles system adopts D2D communication (that is a direct communication method from device to device), which enables higher spectrum efficiency and lower transmission latency. For D2D communication, the Third Generation Partnership Project (3GPP) defines two transmission modes: Mode 1 and Mode 2. Mode 1 and Mode 2 are described below.

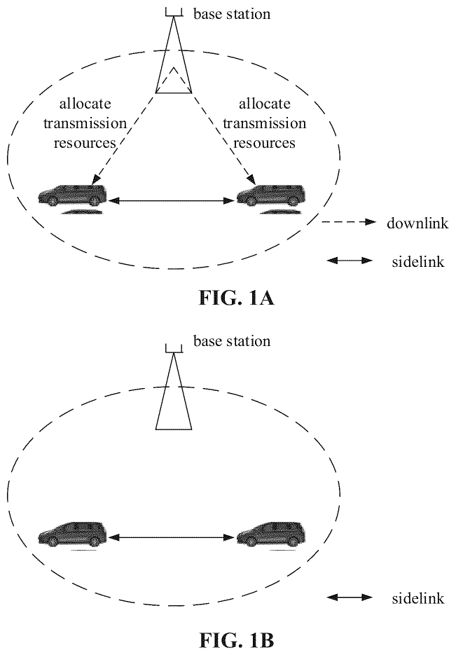

Mode 1: As shown in FIG. 1A, transmission resources for terminal devices are allocated by a base station. Based on the resources allocated by the base station, the terminal devices may transmit data on the sidelink. The base station may allocate resources for a single transmission or resources for a semi-static transmission for the terminal devices.

Mode 2: As shown in FIG. 1B, a terminal device selects a resource in a resource pool for data transmission. Specifically, the terminal device may select a transmission resource in the resource pool by listening or by random selection.

In 3GPP, D2D communication is divided into the following different stages for research.

Proximity based Service (ProSe): Device-to-device communication is studied for ProSe scenarios, which is mainly aimed at public safety services. In ProSe, by configuring a location of a resource pool in time domain, such as making the resource pool discontinuous in the time domain, the purpose of discontinuous transmitting/receiving on a sidelink by terminal devices is achieved, thereby achieving the effect of power saving.

Vehicle to Everything (V2X): Device-to-device communication is studied for communication scenarios of vehicles to other devices, which is mainly oriented to the services of relatively high-speed moving vehicle-to-vehicle and vehicle-to-pedestrian communications. In V2X, the power efficiency is not the main problem because the on-board system has continuous power supply, while the time-delay of data transmission is the main problem. Therefore, the system design requires terminal devices to perform continuous transmission and reception.

Further Enhancement Device to Device (FeD2D): Device-to-device communication is studied for scenarios in which wearable devices access a network by mobile phones. It is mainly oriented to the scenarios with low moving speed and low power access. In FeD2D, in the pre-research stage, 3GPP concluded that a base station can configure DRX parameters of remote terminal devices by a relay terminal device.

With the evolution of mobile communication systems, LTE V2X has also evolved into New Radio (NR) V2X. NR V2X needs to support autonomous driving, so it puts forward higher requirements for data interactions between vehicles, such as higher throughput, lower time-delay, higher reliability, larger coverage, more flexible resource allocation, etc. NR V2X, based on LTE V2X, is not limited to broadcast scenarios, but further expands to unicast and multicast scenarios, and application of V2X is studied in these scenarios. For unicast transmission, there is only one terminal device at a receiving end. For multicast transmission, there are all terminal devices of a communication group or all terminal devices within a transmission distance at a receiving end. For broadcast transmission, there is any terminal device at a receiving end. In an NR V2X system, a variety of transmission modes has been introduced, including Mode 1 and Mode 2. Mode 1 refers to that a network device allocates a transmission resource for a terminal device, and Mode 2 refers to that a terminal device selects a transmission resource. Furthermore, a terminal device may be in a mixed mode, specifically, both Mode 1 and Mode 2 can be used together to acquire a resource. In addition, in the NR V2X system, a sidelink feedback mechanism, namely Hybrid Automatic Repeat reQuest (HARQ) retransmission based on feedback, has been introduced. The sidelink feedback mechanism is not limited to unicast scenarios, but can be applied to multicast scenarios.

### Carrier Aggregation (CA)

CA is a bandwidth expansion technology that can aggregate multiple component carriers (CC) for simultaneous reception or transmission by one terminal device or network device. Based on the range of aggregated carriers, CA can be divided into Intra-band CA and Inter-band CA. One of the main uses of Intra-band CA is for scenarios in which a carrier bandwidth of a cell is larger than a single carrier bandwidth capability of a terminal device. In this case, the terminal device can use CA to implement operations in a “wide carrier”. For example, a base station supports a carrier frequency of 300 MHZ, while a terminal device supports a maximum carrier frequency of 100 MHz. The terminal device can perform broadband operations greater than 100 MHz using CA. The aggregated carriers can be adjacent carriers or non-adjacent carriers.

When a terminal device and a network device communicate using CA, a Primary Cell (PCell) and a Secondary Cell (SCell) may be configured simultaneously. A beam failure recovery mechanism is designed for the PCell and the SCell, the main functional modules (or main operations) of which include: Beam Failure Detection (BFD), New Beam Identification (NBI), Beam Failure Recovery reQest (BFRQ), and network side response. Specifically, the terminal device measures a downlink transmission beam so as to determine the link quality corresponding to the downlink transmission beam. When the corresponding link quality is poor, it is considered that the downlink beam has a beam failure. The terminal device will measure a set of candidate beams, and select a beam that meets a threshold as a new beam. Then, the terminal device notifies the network of a beam failure through a beam failure recovery request, and reports the new beam. After receiving the beam failure recovery request from the terminal device, the network knows that the terminal device has experienced the beam failure, and the network selects to transmit a Physical Downlink Control Channel (PDCCH) on the new beam. In response to the terminal device receiving the PDCCH from the network on the new beam, it is considered to have received a response from the network side correctly. At this point, the procedure of beam failure recovery is successfully completed.

CA technology has also been introduced in LTE V2X. Carrier selection in LTE V2X is implemented by the following mechanism: an upper layer is configured with a mapping relationship between service types and carriers, so that, for a type of service, the upper layer indicates a carrier or a set of carriers available for an Access Stratum (AS) layer. Further, the AS layer is configured with a carrier or a set of carriers available for each logical channel and configured with a Channel Busy Rate (CBR) threshold for data priority in each resource pool. The terminal device measures a CBR value in a resource pool and compares the CBR value with the CBR threshold corresponding to data priority. If the measured CBR value is lower than the CBR threshold, it is considered that the carrier corresponding to the resource pool is available.

There is also a need for NR SL to introduce carrier aggregation technology. Compared with LTE V2X, introduction of carrier aggregation technology in NR SL requires additional consideration as NR V2X supports unicast communication, and how to support carrier aggregation in unicast sidelink communication needs to be improved. Therefore, the following technical solutions in embodiments of the disclosure are provided.

For convenience of understanding of technical solutions in embodiments of the disclosure, the technical solutions in the disclosure are described in detail below based on specific embodiments. The above related technologies, as an alternative, can be arbitrarily combined with the technical solutions in embodiments of the disclosure, and they are all within the scope of protection of embodiments of the disclosure. Embodiments of the disclosure include at least part of the following.

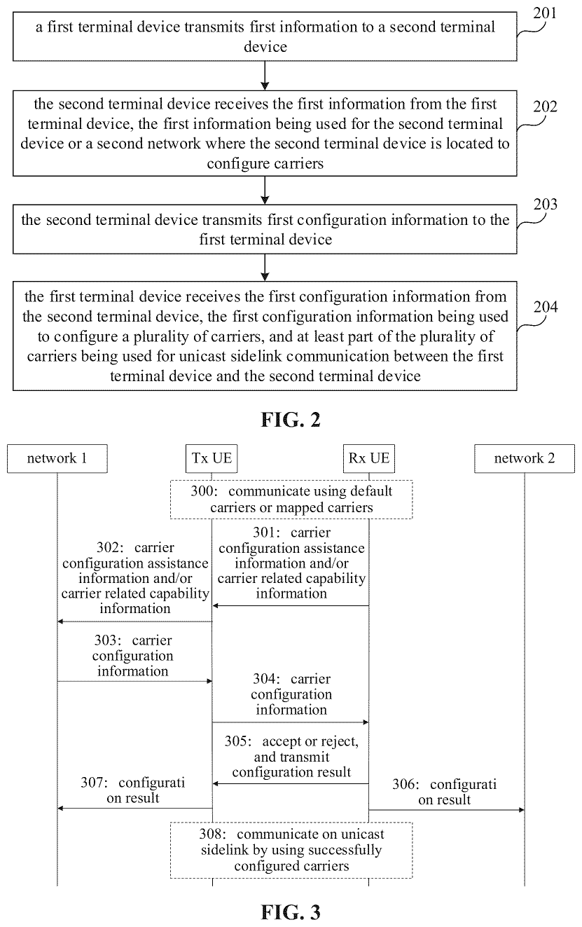

FIG. 2 is a schematic flowchart of a method for carrier configuration provided in an embodiment of the disclosure. As shown in FIG. 2, the method for carrier configuration includes the following operations.

In operation 201: a first terminal device transmits first information to a second terminal device.

In operation 202: the second terminal device receives the first information from the first terminal device. The first information is used for the second terminal device or a second network where the second terminal device is located to configure carriers.

In some embodiments, the first terminal device may be a transmitting terminal of unicast sidelink communication, and the second terminal device may be a receiving terminal of the unicast sidelink communication. In other embodiments, the first terminal device may be a receiving terminal of the unicast sidelink communication, and the second terminal device may be a transmitting terminal of the unicast sidelink communication.

For the transmitting terminal of the unicast sidelink communication, the transmitting terminal transmits data on a unicast sidelink. For the receiving terminal of the unicast sidelink communication, the receiving terminal receives data on the unicast sidelink.

In the embodiment of the disclosure, the unicast sidelink communication between the first terminal device and the second terminal device supports carrier aggregation, that is, communication is carried out over the unicast sidelink through aggregated carriers. In order to implement the carrier aggregation on the unicast sidelink, corresponding carrier configuration is needed. Specifically, the first terminal device transmits the first information to the second terminal device, and the second terminal device receives the first information from the first terminal device. The first information is used for the second terminal device or a second network where the second terminal device is located to configure carriers.

In some embodiments, the first information may include a carrier or a set of carriers suggested by the first terminal device for configuration and/or a carrier or a set of carriers supported by a capability of the first terminal device. The information corresponding to the carrier or the set of carriers suggested by the first terminal device for configuration may also be referred to as carrier configuration assistance information, which is not limited in the disclosure. The information corresponding to the carrier or the set of carriers supported by the capability of the first terminal device may also be referred to as carrier related capability information, which is not limited in the disclosure.

In some embodiments, the carrier or the set of carriers suggested by the first terminal device for configuration may be determined based on at least one of:
a carrier or a set of carriers supported by the capability of the first terminal device;
a carrier or a set of carriers used by the first terminal device;
a carrier or a set of carriers available to the first terminal device;
a carrier or a set of carriers supported by a capability of the second terminal device;
a carrier or a set of carriers used by the second terminal device;
a carrier or a set of carriers available to the second terminal device;
communication information of the unicast sidelink communication between the first terminal device and the second terminal device;
a link quality of a unicast sidelink between the first terminal device and the second terminal device;
a network configuration of a first network where the first terminal device is located, the network configuration of the first network being used to configure a carrier or a set of carriers supported by one or more coverage ranges of the first network; or
a network capability of the first network where the first terminal device is located, the network capability of the first network being used to determine whether the first network supports carrier aggregation.

In some embodiments, the carrier or the set of carriers supported by the capability of the first terminal device may be determined based on at least one of:
a carrier or a set of carriers used by the first terminal device;
a carrier or a set of carriers available to the first terminal device; or
a network capability of a first network where the first terminal device is located,
the network capability of the first network being used to determine whether the first network supports carrier aggregation.

In the above solutions, the carrier or the set of carriers used by the first terminal device refers to a carrier or a set of carriers on other sidelinks and/or uplinks and downlinks than the unicast sidelink of the first terminal device.

In the above solutions, the carrier or the set of carriers available to the first terminal device refers to a carrier or a set of carriers obtained by removing the carrier or the set of carriers used by the first terminal device from the carrier or the set of carriers supported by the capability of the first terminal device.

In the above solutions, the carrier or the set of carriers used by the second terminal device refers to a carrier or a set of carriers on other sidelinks and/or uplinks and downlinks than the unicast sidelink of the first second device.

In the above solutions, the carrier or the set of carriers available to the second terminal device refers to a carrier or a set of carriers obtained by removing the carrier or the set of carriers used by the second terminal device from the carrier or the set of carriers supported by the capability of the second terminal device.

In the above solutions, the first terminal device may, but is not limited to, acquire information related to the second terminal device (i.e., at least one of the carrier or the set of carriers supported by the capability of the second terminal device, the carrier or the set of carriers used by the second terminal device, or the carrier or the set of carriers available to the second terminal device) in the following manners.

Manner 1-1: the first terminal device transmits request information to the second terminal device, and the request information is used to request the second terminal device to report information related to the second terminal device. After receiving the request information, the second terminal device reports the information related to the second terminal device to the first terminal device, and the first terminal device receives the information related to the second terminal device from the second terminal device.

Manner 1-2: the first terminal device receives information related to the second terminal device actively transmitted by the second terminal device.

In the above solutions, the first terminal device may, but is not limited to, acquire communication information of the unicast sidelink communication between the first terminal device and the second terminal device in the following manners.

Manner 2-1: when the first terminal device is a transmitting terminal of the unicast sidelink communication, the first terminal device naturally knows the communication information of the unicast sidelink communication between the first terminal device and the second terminal device.

Manner 2-2: when the first terminal device is a receiving terminal of the unicast sidelink communication, the first terminal device receives the communication information of the unicast sidelink communication form the second terminal device.

In some embodiments, the communication information of the unicast sidelink communication may include at least one of the following information related to the communication: a data volume, a data type, or a logical channel identifier.

In the above solutions, the first terminal device may, but is not limited to, acquire a link quality of the unicast sidelink communication between the first terminal device and the second terminal device in the following manners.

Manner 3-1: the first terminal device measures a reference signal from the second terminal device, and determines the link quality of the unicast sidelink communication between the first terminal device and the second terminal device based on a measurement result of the reference signal.

Manner 3-2: the second terminal device measures a reference signal from the first terminal device, and reports a measurement result of the reference signal to the first terminal device, so that the first terminal device acquires the link quality of the unicast sidelink communication between the first terminal device and the second terminal device.

In some embodiments, the measurement result of the reference signal may be a measurement value of Reference Signal Receiving Power (RSRP) of the reference signal, a Reference Signal Received Quality (RSRQ), or the like.

In the above solutions, the first terminal device may, but is not limited to, acquire a network configuration and/or a network capability of a first network where the first terminal device is located in the following manners.

Manner 4-1: the first terminal device receives a system broadcast message from the first network, and the system broadcast message carries a network configuration and/or a network capability of the first network. The first terminal device obtains the network configuration and/or the network capability of the first network from the system broadcast message.

Manner 4-2: the first terminal device transmits request information to the first network, and the request information is used to request the first network to transmit a network configuration and/or a network capability of the first network. The first terminal device receives the network configuration and/or the network capability of the first network transmitted by the first network.

In some embodiments, the network configuration of the first network is used to configure a carrier or a set of carriers supported by one or more coverage ranges of the first network. The network capability of the first network is used to determine whether the first network supports carrier aggregation. The network capability of the first network may be capability information or network version information. The capability information explicitly indicates whether the first network supports carrier aggregation, and the network version information implicitly indicates whether the first network supports carrier aggregation.

It should be noted that the prerequisite for the first terminal device to acquire the network configuration and/or the network capability of the first network includes at least one of following cases: the first terminal device is within a coverage range of the first network, the first terminal device is in the Mode 1 state, or the first terminal device is in a connected state.

In an embodiment of the disclosure, the first terminal device may transmit the first information to the second terminal device in response to a trigger condition being determined to be satisfied.

In some embodiments, the trigger condition may include at least one of followings: a first trigger condition, a second trigger condition, a third trigger condition or a fourth trigger condition.

The first trigger condition refers to that the first terminal device receives request information from the second terminal device and the request information is used to request the first terminal device to transmit the first information to the second terminal device.

The second trigger condition refers to that the first terminal device receives first indication information from the second terminal device and the first indication information is used to indicate that the second terminal device and/or a second network where the second terminal device is located supports sidelink carrier aggregation.

The third trigger condition refers to that the first terminal device determines that a periodic time point has arrived.

The fourth trigger condition refers to that the first terminal device determines that a target event has occurred.

As some implementations, the target event may include at least one of the followings:
the carrier or the set of carriers suggested by the first terminal device for configuration is changed;
a unicast sidelink is established between the first terminal device and the second terminal device;
the carrier or the set of carriers used by the first terminal device is changed;
the carrier or the set of carriers available to the first terminal device is changed;
a link quality of the unicast sidelink between the first terminal device and the second terminal device is changed; or
a conflict occurs in a carrier resource on the unicast sidelink between the first terminal device and the second terminal device.

In some embodiments, before all or part of the plurality of carriers configured by the first configuration information is successfully configured, the first terminal device and the second terminal device may communicate by using a first carrier or a second carrier. The first carrier is a default carrier or a carrier in a default set of available carriers or a carrier determined based on a first mapping rule, and the second carrier is a carrier that has been successfully configured before the first terminal device receives the first configuration information. In an example, the first mapping rule may include a mapping relationship between third information and available carriers and/or available carrier numbers. The third information may include at least one of:
a layer 2 ID(s) of the first terminal device and/or the second terminal device;
a Tx profile corresponding to data transmission between the first terminal device and the second terminal device;
a service type or application type corresponding to data transmission between the first terminal device and the second terminal device;
a data volume corresponding to data transmission between the first terminal device and the second terminal device;
a transmission type corresponding to data transmission between the first terminal device and the second terminal device;
a QoS flow corresponding to data transmission between the first terminal device and the second terminal device;
a logical channel corresponding to data transmission between the first terminal device and the second terminal device;
a resource pool corresponding to data transmission between the first terminal device and the second terminal device;
a radio bearer corresponding to data transmission between the first terminal device and the second terminal device;
a data priority corresponding to data transmission between the first terminal device and the second terminal device; or
a channel busy rate of the resource pool corresponding to data transmission between the first terminal device and the second terminal device.

The Layer 2 ID is a communication address used by the terminal device(s) for sidelink communication.

The transmission type may be a broadcast type, a unicast type, or a multicast type. For the solutions in embodiments of the disclosure, the transmission type is a unicast type.

In operation 203: the second terminal device transmits first configuration information to the first terminal device.

In operation 204: the first terminal device receives the first configuration information from the second terminal device. The first configuration information is used to configure a plurality of carriers, and at least part of the plurality of carriers is used for unicast SL communication between the first terminal device and the second terminal device.

In an embodiment of the disclosure, the first information is used for the second terminal device or a second network where the second terminal device is located to configure carriers. The following provides explanations based on different cases.

Solution 1-1: the first information is used for the second terminal device to configure carriers.

The solution 1-1 may, but is not limited to, be applicable to the following scenarios: the second terminal device is outside of a coverage range of the second network, the second terminal device is in a disconnected state, or the second terminal device is in the Mode 2 state.

After receiving the first information from the first terminal device, the second terminal device may configure carriers based on the first information to generate first configuration information. The second terminal device transmits the first configuration information to the first terminal device, and the first terminal device receives the first configuration information from the second terminal device. The first configuration information is used to configure multiple carriers.

The solution 1-1 may also be applicable to the following scenarios: the first terminal device is within the coverage range of the first network, the first terminal device is in the connected state, or the first terminal device is in the Mode 1 state.

Solution 1-2: the first information is used for the second network where the second terminal device is located to configure carriers.

The solution 1-2 is applicable to the following scenarios: the second terminal device is within of the coverage range of the second network, the second terminal device is in the connected state, or the second terminal device is in the Mode 1 state.

After receiving the first information from the first terminal device, the second terminal device may forward the first information to the second network. The first information may be forwarded by the second terminal device to the second network, and the second network may configure carriers based on the first information to generate the first configuration information. The second terminal device may receive the first configuration information from the second network. The second terminal device may transmit the first configuration information to the first terminal device, and the first terminal device may receive the first configuration information forwarded by the second terminal device from the second network. The first configuration information is used to configure multiple carriers.

In an embodiment of the disclosure, after the first terminal device receives the first configuration information from the second terminal device, the first terminal device or the first network where the first terminal device is located may determine whether to accept or reject all or part of the plurality of carriers configured by the first configuration information. The following provides explanations based on different cases.

Solution 2-1: the first terminal device determines whether to accept or reject all or part of the plurality of carriers configured by the first configuration information.

The solution 2-1 may, but is not limited to, be applicable to the following scenarios: the first terminal device is outside of the coverage range of the first network, the first terminal device is in a disconnected state, or the first terminal device is in the Mode 2 state.

After receiving the first configuration information from the second terminal device, the first terminal device may accept or reject all or part of the plurality of carriers configured by the first configuration information, and may transmit a configuration result corresponding to the first configuration information to the second terminal device. The configuration result may include at least one of followings:
second indication information, used for indicating acceptance or rejection of all or part of the plurality of carriers configured by the first configuration information;
first carrier information, used for indicating accepted carriers; or
second carrier information, used for indicating rejected carriers.

The accepted carriers are successfully configured carriers. The first carrier information may also be referred to as configuration success information, which is not limited in the disclosure. As an example, the first carrier information may include carrier identifiers of the accepted carriers.

The rejected carriers are carriers failed to be configured. The second carrier information may also be referred to as configuration failure information, which is not limited in the disclosure. As an example, the second carrier information may include carrier identifiers of the rejected carriers.

The solution 2-1 may also be applicable to the following scenarios: the first terminal device is within the coverage range of the first network, the first terminal device is in the connected state, or the first terminal device is in the Mode 1 state. For such a scenario, in some embodiments, the first terminal device may transmit a configuration result to the first network where the first terminal device is located.

Solution 2-2: the first network where the first terminal device is located determines whether to accept or reject all or part of the plurality of carriers configured by the first configuration information.

The solution 2-2 is applicable to the following scenarios: the first terminal device is within the coverage range of the first network, the first terminal device is in the connected state, or the first terminal device is in the Mode 1 state.

After receiving the first configuration information from the second terminal device, the first terminal device may transmit the first configuration information to the first network where the first terminal device is located. After receiving the first configuration information from the first terminal device, the first network may accept or reject all or part of the plurality of carriers configured by the first configuration information, and transmit a configuration result corresponding to the first configuration information to the first terminal device. The first terminal device may receive the configuration result corresponding to the first configuration information from the first network. Furthermore, the first terminal device may transmit the configuration result corresponding to the first configuration information to the second terminal device. The second terminal device may receive the configuration result corresponding to the first configuration information from the first terminal device. The configuration result may include at least one of followings:
second indication information, used for indicating acceptance or rejection of all or part of the plurality of carriers configured by the first configuration information; or
first carrier information, used for indicating accepted carriers; or
second carrier information, used for indicating rejected carriers.

The accepted carriers are successfully configured carriers. The first carrier information may also be referred to as configuration success information, which is not limited in the disclosure. As an example, the first carrier information may include carrier identifiers of the accepted carriers.

The rejected carriers are carriers failed to be configured. The second carrier information may also be referred to as configuration failure information, which is not limited in the disclosure. As an example, the second carrier information may include carrier identifiers of the rejected carriers.

In some embodiments, in response to the second indication information being used for indicating rejection of all or part of the plurality of carriers configured by the first configuration information, the second terminal device may perform at least one of the following operations:
reconfiguring a plurality of carriers based on the first information, and transmitting the first configuration information to the first terminal device, the first configuration information being used to reconfigure the plurality of carriers;
triggering a link failure procedure of the unicast sidelink; or
disconnecting the unicast sidelink is disconnected.

In some embodiments, the second terminal device may transmit the configuration result to the second network where the second terminal device is located. Alternatively, the second terminal device may transmit final carrier configurations to the second network where the second terminal device is located based on the configuration result. A prerequisite for the second terminal device to transmit the configuration result to the second network where the second terminal device is located may include at least one of cases: the second terminal device is within of the coverage range of the second network, the second terminal device is in the connected state, or the second terminal device is in the Mode 1 state.

In some embodiments, in the scenario that the second indication information is used for indicating acceptance of all or part of the plurality of carriers configured by the first configuration information, the accepted carriers indicated by the first carrier information are used for the unicast sidelink communication between the first terminal device and the second terminal device. Alternatively, in the scenario that the second indication information is used for indicating rejection of part of the plurality of carriers configured by the first configuration information, carriers other than the rejected carrier indicated by the second carrier information among all of the plurality of carriers configured by the first configuration information are used for the unicast sidelink communication between the first terminal device and the second terminal device.

In some embodiments, in response to all or part of the plurality of carriers configured by the first configuration information being failed to be configured, the first terminal device and the second terminal device may communicate with each other by using a first carrier or a second carrier or a third carrier. The first carrier is a default carrier or a carrier in a default set of available carriers or a carrier determined based on a first mapping rule, the second carrier is a carrier that has been successfully configured before the first terminal device receives the first configuration information, and the third carrier is a carrier in part of successfully configured carriers among the plurality of carriers. In an example, the first mapping rule may include a mapping relationship between third information and available carriers and/or available carrier numbers. The third information may include at least one of followings:
a layer 2 ID(s) of the first terminal device and/or the second terminal device;
a Tx profile corresponding to data transmission between the first terminal device and the second terminal device;
a service type or application type corresponding to data transmission between the first terminal device and the second terminal device;
a data volume corresponding to data transmission between the first terminal device and the second terminal device;
a transmission type corresponding to data transmission between the first terminal device and the second terminal device;
a QoS flow corresponding to data transmission between the first terminal device and the second terminal device;
a logical channel corresponding to data transmission between the first terminal device and the second terminal device;
a resource pool corresponding to data transmission between the first terminal device and the second terminal device;
a radio bearer corresponding to data transmission between the first terminal device and the second terminal device;
a data priority corresponding to data transmission between the first terminal device and the second terminal device; or

a channel busy rate of the resource pool corresponding to data transmission between the first terminal device and the second terminal device.

The Layer 2 ID is a communication address used by the terminal device for sidelink communication.

The transmission type may be a broadcast type, a unicast type, or a multicast type. For the solutions in embodiments of the disclosure, the transmission type is a unicast type.

It should be noted that the first carrier, the second carrier, or the third carrier in the above solutions may be one carrier or a plurality of carriers.

In embodiments of the disclosure, interaction between the first terminal device and the second terminal device is based on a PC5 interface. In some embodiments, the first information transmitted from the first terminal device to the second terminal device may be carried in PC5 interface-based RRC signaling (PC5-RRC signaling), Sidelink Control Information (SCI), or SideLink MAC CE (SL-MAC CE). In some embodiments, the first configuration information transmitted from the second terminal device to the first terminal device may be carried in PC5-RRC signaling, or SCI, or MAC CE.

The technical solutions in embodiments of the disclosure are exemplified in combination with specific application instances below.

### Application Instance 1

In this application instance, the first terminal device is a receiving terminal of unicast sidelink communication (denoted by Rx UE), and the second terminal device is a transmitting terminal of the unicast sidelink communication (denoted by Tx UE). The network where the first terminal device is located is denoted by the network 2, and the network where the second terminal device is located is denoted by the network 1. The carriers are configured by the Tx UE or the network 1 where the Tx UE is located. The specific processes are illustrated in FIG. 3, including the following operations.

In operation 300: the Tx UE and the Rx UE communicate with each other using default carriers or mapped carriers.

The default carrier may be defined by a protocol, and both the Tx UE and the Rx UE know the default carrier.

The mapped carrier may be determined based on a first mapping rule. In an example, the first mapping rule may include a mapping relationship between third information and available carriers and/or available carrier numbers. The third information may include at least one of followings: a layer 2 ID(s) of the Tx UE and/or the Rx UE, a Tx profile corresponding to data transmission between the Tx UE and the Rx UE, a service type or application type corresponding to data transmission between the Tx UE and the Rx UE, a data volume corresponding to data transmission between the Tx UE and the Rx UE, a transmission type corresponding to data transmission between the Tx UE and the Rx UE, a QoS flow corresponding to data transmission between the Tx UE and the Rx UE, a logical channel corresponding to data transmission between the Tx UE and the Rx UE, a resource pool corresponding to data transmission between the Tx UE and the Rx UE, a radio bearer corresponding to data transmission between the Tx UE and the Rx UE, a data priority corresponding to data transmission between the Tx UE and the Rx UE, or a CBR of a resource pool corresponding to data transmission between the Tx UE and the Rx UE. The Tx UE acquires third information, and determines carriers corresponding to the third information (i.e., the mapped carriers) based on the first mapping rule. The Rx UE may acquire the third information from the Tx UE, and determine carriers corresponding to the third information (i.e., the mapped carriers) based on the first mapping rule.

It should be noted that, before carriers for the unicast sidelink communication between the Tx UE and the Rx UE are configured, the Tx UE and the Rx UE communicate with each other using the default carriers, or carriers in the default set of available carriers, or the mapped carriers. For example, the Tx UE or the Rx UE may transmit or receive a discovery message, a Direct Communication Request (DCR) message, other PC5-S messages, a PC5-RRC message, and the like using the default carriers or the carriers in the default set of available carriers or the mapped carriers.

In operation 301: the Rx UE transmits carrier configuration assistance information and/or carrier related capability information to the Tx UE.

The carrier configuration assistance information and/or the carrier related capability information is the first information in the above solutions. The carrier configuration assistance information may include a carrier or a set of carriers suggested by the Rx UE for configuration, and the carrier related capability information may include a carrier or a set of carriers supported by the capability of the Rx UE.

The conditions that trigger the Rx UE to transmit the carrier configuration assistance information and/or the carrier related capability information to the Tx UE may include at least one of followings:
a first trigger condition including that the Rx UE receives request information from the Tx UE, the request information being used for requesting the Rx UE to transmit the carrier configuration assistance information and/or the carrier related capability information to the Tx UE;
a second trigger condition including that the Rx UE receives first indication information from the Tx UE, the first indication information being used to indicate that the Tx UE and/or the network 1 where the Tx UE is located support sidelink carrier aggregation;
a third trigger condition including that the Rx UE determines that a periodic time point has arrived; or
a fourth trigger condition including that the Rx UE determines that a target event has occurred.

The trigger corresponding to the third trigger condition may also be referred to as a periodic trigger.

The trigger corresponding to the fourth trigger condition may also be referred to as a target event based trigger. As some implementations, the target event may include at least one of the followings:
the carrier or the set of carriers suggested by the Rx UE for configuration is changed;
the Rx UE establishes a unicast sidelink with the Tx UE;
the carrier or the set of carriers used by the Rx UE is changed;
the carrier or the set of carriers available to the Rx UE is changed;
the link quality of the unicast sidelink between the Rx UE and the Tx UE is changed; or
a conflict occurs in a carrier resource on the unicast sidelink between the Rx UE and the Tx UE.

It should be noted that, in the case of the periodic trigger and the target event based trigger, the Rx UE needs to confirm that the Tx UE has the capability of carrier aggregation. In the case that the Tx UE has the capability of carrier aggregation, when the target event occurs, the Rx UE may transmit the carrier configuration assistance information and/or the carrier related capability information to the Tx UE.

In the above solutions, the carrier configuration assistance information (i.e., the carrier or the set of carriers suggested by the Rx UE for configuration) may be determined by the Rx UE based on at least one of:
the carrier or the set of carriers supported by the capability of the Rx UE;
the carrier or the set of carriers used by the Rx UE;
the carrier or the set of carriers available to the Rx UE;
the carrier or the set of carriers supported by the capability of the Tx UE;
the carrier or the set of carriers used by the Tx UE;
the carrier or the set of carriers available to the Tx UE;
communication information of the unicast sidelink communication between the Rx UE and the Tx UE;
the link quality of the unicast sidelink between the Rx UE and the Tx UE;
a network configuration of the network 2 where the Rx UE is located, the network configuration of the network 2 is used to configure a carrier or a set of carriers supported by one or more coverage ranges of the network 2; or
a network capability of the network 2 where the Rx UE is located, the network capability of the network 2 is used to determine whether the network 2 supports carrier aggregation.

In the above solutions, the carrier related capability information (i.e., the carrier or the set of carriers supported by the capability of the Rx UE) may be determined by the Rx UE based on at least one of:
the carrier or the set of carriers used by the Rx UE;
the carrier or the set of carriers available to the Rx UE; or
the network capability of the network 2 where the Rx UE is located, the network capability of the network 2 is used to determine whether the network 2 supports carrier aggregation.

In operation 302: the Tx UE reports the carrier configuration assistance information and/or the carrier related capability information obtained from the Rx UE to the network 1.

In operation 303: the network 1 transmits carrier configuration information to the Tx UE.

The carrier configuration information is the first configuration information in the above solutions, and is used to configure multiple carriers.

In operation 304: the Tx UE transmits the carrier configuration information to the Rx UE.

In operation 305: the Rx UE accepts or rejects all or part of the carriers configured by the carrier configuration information, and transmits the configuration result to the Tx UE.

The accepted carriers may be understood as successfully configured carriers. The rejected carriers may be understood as carriers failed to be configured.

When the Rx UE accepts all of the carriers configured by the carrier configuration information, it may be understood that all of the carriers configured by the carrier configuration information are successfully configured (or it may be directly understood that the carrier configuration information is successfully configured). When the Rx UE rejects all of the carriers configured by the carrier configuration information, it may be understood that all of the carriers configured by the carrier configuration information have failed to be configured (or it may be directly understood that the carrier configuration information has failed to be configured).

When the Rx UE accepts part of the carriers configured by the carrier configuration information, it may be understood that the part of the carriers configured by the carrier configuration information is successfully configured (or it may be directly understood that the carrier configuration information is successfully configured partially). When the Rx UE rejects part of the carriers configured by the carrier configuration information, it may be understood that the part of the carriers configured by the carrier configuration information has failed to be configured (or it may be directly understood that the carrier configuration information has failed to be configured partially).

The configuration result may include at least one of: indication information for indicating acceptance or rejection of all or part of the carriers configured by the carrier configuration information, carrier information (e.g., carrier identifier) for indicating the accepted carriers, or carrier information (e.g. carrier identifier) for indicating the rejected carriers.

In operation 306: the Rx UE reports the configuration result to the network 2.

The configuration result may include at least one of: indication information for indicating acceptance or rejection of all or part of the carriers configured by the carrier configuration information, carrier information (e.g., carrier identifier) for indicating the accepted carriers, or carrier information (e.g. carrier identifier) for indicating the rejected carriers.

In operation 307: the Tx UE reports the configuration result to the network 1.

The configuration result may include at least one of: indication information for indicating acceptance or rejection of all or part of the carriers configured by the carrier configuration information, carrier information (e.g., carrier identifier) for indicating the accepted carriers, or carrier information (e.g. carrier identifier) for indicating the rejected carriers.

In response to the indication information in the configuration result indicating that all or part of the carriers configured by the carrier configuration information is rejected (that is, all or part of the carrier configuration information has failed to be configured), the Tx UE may perform at least one of the following operations:
reconfiguring carriers (i.e. re-performing the operations 302 to 304 described above);
triggering a link failure procedure of the unicast sidelink; or
disconnecting the unicast sidelink.

In operation 308: in response to all or part of the carrier configuration information being successfully configured, the Tx UE and the Rx UE communicate on the unicast sidelink by using the successfully configured carriers.

It should be noted that, in a case that the Tx UE is outside the coverage range of the network 1 and/or the Tx UE is in the disconnected state and/or the Tx UE is in the Mode 2 state, the operations 302, 303, and 307 described above will not be performed. In this case, the Tx UE may determine the carrier configuration information autonomously after the operation 301 and execute the operation 304.

It should be noted that, in a case that the Rx UE is outside the coverage range of the network 2 and/or the Rx UE is in the disconnected state and/or the Rx UE is in the Mode 2 state, the operation 306 described above will not be performed.

It should be noted that, in a case that the Rx UE is within the coverage range of the network 2 and/or the Rx UE is in the connected state and/or the Rx UE is in the Mode 1 state, the operation 305 described above may be replaced with the following operations 305a and 305b, and the operation 306 described above may be replaced with the following operation 306a.

In operation 305a: the Rx UE reports the carrier configuration information to the network 2.

In operation 305b: the network 2 accepts or rejects all or part of the carriers configured by the carrier configuration information, and transmits the configuration result to the Rx UE.

In operation 306a: the Rx UE transmits the configuration result to the Tx UE.

### Application Instance 2

In this application instance, the first terminal device is a transmitting terminal of unicast sidelink communication (denoted by Tx UE), and the second terminal device is a receiving terminal of the unicast sidelink communication (denoted by Rx UE). The network where the first terminal device is located is denoted by the network 1, and the network where the second terminal device is located is denoted by the network 2. Carriers are configured by the Rx UE or the network 2 where the Rx UE is located. The specific processes are illustrated in FIG. 4, including the following operations.

In operation 400: the Rx UE and the Tx UE communicate with each other using default carriers or mapped carriers.

The default carrier may be defined by a protocol, and both the Rx UE and the Tx UE know the default carrier.

The mapped carrier may be determined based on a first mapping rule. In an example, the first mapping rule may include a mapping relationship between third information and available carriers and/or available carrier numbers. The third information may include at least one of: a layer 2 ID(s) of the Tx UE and/or the Rx UE, a Tx profile corresponding to data transmission between the Tx UE and the Rx UE, a service type or application type corresponding to data transmission between the Tx UE and the Rx UE, a data volume corresponding to data transmission between the Tx UE and the Rx UE, a transmission type corresponding to data transmission between the Tx UE and the Rx UE, a QoS flow corresponding to data transmission between the Tx UE and the Rx UE, a logical channel corresponding to data transmission between the Tx UE and the Rx UE, a resource pool corresponding to data transmission between the Tx UE and the Rx UE, a radio bearer corresponding to data transmission between the Tx UE and the Rx UE, a data priority corresponding to data transmission between the Tx UE and the Rx UE, or a CBR of a resource pool corresponding to data transmission between the Tx UE and the Rx UE. The Tx UE may acquire third information, and determine carriers corresponding to the third information (i.e., the mapped carriers) based on the first mapping rule. The Rx UE may acquire the third information from the Tx UE, and determine carriers corresponding to the third information (i.e., the mapped carriers) based on the first mapping rule.

It should be noted that, before carriers for the unicast sidelink communication between the Rx UE and the Tx UE are configured, the Rx UE and the Tx UE may communicate using the default carriers, the carriers in the default set of available carriers, or the mapped carriers. For example, the Rx UE or the Tx UE may transmit or receive a discovery message, a DCR message, other PC5-S messages, a PC5-RRC message, and the like using the default carriers or the carriers in the default set of available carriers or the mapped carriers.

In operation 401: the Tx UE transmits carrier configuration assistance information and/or carrier related capability information to the Rx UE.

The carrier configuration assistance information and/or the carrier related capability information is the first information in the above solutions. The carrier configuration assistance information may include a carrier or a set of carriers suggested by the Tx UE for configuration, and the carrier related capability information may include a carrier or a set of carriers supported by the capability of the Tx UE.

The conditions that trigger the Tx UE to transmit the carrier configuration assistance information and/or the carrier related capability information to the Rx UE may include at least one of:
a first trigger condition including that the Tx UE receives request information from the Rx UE, the request information being used for requesting the Tx UE to transmit the carrier configuration assistance information and/or the carrier related capability information to the Rx UE;
a second trigger condition including that the Tx UE receives first indication information from the Rx UE, the first indication information being used to indicate that the Rx UE and/or the network 2 where the Rx UE is located support sidelink carrier aggregation;
a third trigger condition including that the Tx UE determines that a periodic time point has arrived; or
a fourth trigger condition including that the Tx UE determines that a target event has occurred.

The trigger corresponding to the third trigger condition may also be referred to as a periodic trigger.

The trigger corresponding to the fourth trigger condition may also be referred to as a target event based trigger. As some implementations, the target event may include at least one of the followings:
the carrier or the set of carriers suggested by the Tx UE for configuration is changed;
the Tx UE establishes a unicast sidelink with the Rx UE;
the carrier or the set of carriers used by the Tx UE is changed;
the carrier or the set of carriers available to the Tx UE is changed;
the link quality of the unicast sidelink between the Tx UE and the Rx UE is changed; or
a conflict occurs in a carrier resource on the unicast sidelink between the Tx UE and the Rx UE.

It should be noted that, in the case of the periodic trigger and the target event based trigger, the Tx UE needs to confirm that the Rx UE has the capability of carrier aggregation. In the case that the Rx UE has the capability of carrier aggregation, when the target event occurs, the Tx UE may transmit the carrier configuration assistance information and/or the carrier related capability information to the Rx UE.

In the above solutions, the carrier configuration assistance information (i.e., the carrier or the set of carriers suggested by the Tx UE for configuration) may be determined by the Tx UE based on at least one of:
the carrier or the set of carriers supported by the capability of the Tx UE;
the carrier or the set of carriers used by the Tx UE;
the carrier or the set of carriers available to the Tx UE;
the carrier or the set of carriers supported by the capability of the Rx UE;
the carrier or the set of carriers used by the Rx UE;
the carrier or the set of carriers available to the Rx UE;
communication information of the unicast sidelink communication between the Tx UE and the Rx UE;
the link quality of the unicast sidelink between the Tx UE and the Rx UE;
a network configuration of the network 1 where the Tx UE is located, the network configuration of the network 1 is used to configure a carrier or a set of carriers supported by one or more coverage ranges of the network 1; or
a network capability of the network 1 where the Tx UE is located, the network capability of the network 1 is used to determine whether the network 1 supports carrier aggregation.

In the above solutions, the carrier related capability information (i.e., the carrier or the set of carriers supported by the capability of the Tx UE) may be determined by the Tx UE based on at least one of:
the carrier or the set of carriers used by the Tx UE;
the carrier or the set of carriers available to the Tx UE; or
the network capability of the network 1 where the Tx UE is located, the network capability of the network 1 is used to determine whether the network 1 supports carrier aggregation.

In operation 402: the Rx UE reports the carrier configuration assistance information and/or the carrier related capability information obtained from the Tx UE to the network 2.

In operation 403: the network 2 transmits carrier configuration information to the Rx UE.

The carrier configuration information is the first configuration information in the above solutions, and is used to configure multiple carriers.

In operation 404: the Rx UE transmits the carrier configuration information to the Tx UE.

In operation 405: the Tx UE accepts or rejects all or part of the carriers configured by the carrier configuration information, and transmits the configuration result to the Rx UE.

The accepted carriers may be understood as successfully configured carriers. The rejected carriers may be understood as carriers failed to be configured.

When the Tx UE accepts all of the carriers configured by the carrier configuration information, it may be understood that all of the carriers configured by the carrier configuration information are successfully configured (or it may be directly understood that the carrier configuration information is successfully configured). When the Tx UE rejects all of the carriers configured by the carrier configuration information, it may be understood that all of the carriers configured by the carrier configuration information have failed to be configured (or it may be directly understood that the carrier configuration information has failed to be configured).

When the Tx UE accepts part of the carriers configured by the carrier configuration information, it may be understood that the part of the carriers configured by the carrier configuration information is successfully configured (or it may be directly understood that the carrier configuration information is successfully configured partially). When the Tx UE rejects part of the carriers configured by the carrier configuration information, it may be understood that the part of the carriers configured by the carrier configuration information has failed to be configured (or it may be directly understood that the carrier configuration information has failed to be configured partially).

The configuration result may include at least one of: indication information for indicating acceptance or rejection of all or part of the carriers configured by the carrier configuration information, carrier information (e.g., carrier identifier) for indicating the accepted carriers, or carrier information (e.g. carrier identifier) for indicating the rejected carriers.

In operation 406: the Tx UE reports the configuration result to the network 1.

The configuration result may include at least one of: indication information for indicating acceptance or rejection of all or part of the carriers configured by the carrier configuration information, carrier information (e.g., carrier identifier) for indicating the accepted carriers, or carrier information (e.g. carrier identifier) for indicating the rejected carriers.

In operation 407: the Rx UE reports the configuration result to the network 2.

The configuration result may include at least one of: indication information for indicating acceptance or rejection of all or part of the carriers configured by the carrier configuration information, carrier information (e.g., carrier identifier) for indicating the accepted carriers, or carrier information (e.g. carrier identifier) for indicating the rejected carriers.

In response to the indication information in the configuration result indicating that all or part of the carriers configured by the carrier configuration information is rejected (that is, all or part of the carrier configuration information has failed to be configured), the Rx UE may perform at least one of the following operations:
reconfiguring carriers are (i.e. re-performing the operations 402 to 404 described above);
triggering a link failure procedure of the unicast sidelink; or
disconnecting the unicast sidelink.

In operation 408: in response to all or part of the carrier configuration information being successfully configured, the Rx UE and the Tx UE communicate on the unicast sidelink by using the successfully configured carriers.

It should be noted that, in a case that the Rx UE is outside the coverage range of the network 2 and/or the Rx UE is in the disconnected state and/or the Rx UE is in the Mode 2 state, the operations 402, 403, and 407 described above will not be performed. In this case, the Rx UE may determine the carrier configuration information autonomously after the operation 401 and execute the operation 404.

It should be noted that, in a case that the Tx UE is outside the coverage range of the network 1 and/or the Tx UE is in the disconnected state and/or the Tx UE is in the Mode 2 state, the operation 406 described above will not be performed.

It should be noted that, in a case that the Tx UE is within the coverage range of the network 1 and/or the Tx UE is in the connected state and/or the Tx UE is in the Mode 1 state, the operation 405 described above may be replaced with the following operations 405a and 405b, and the operation 406 described above may be replaced with the following operation 406a.

In operation 405a: the Tx UE reports the carrier configuration information to the network 1.

In operation 405b: the network 1 accepts or rejects all or part of the carriers configured by the carrier configuration information, and transmits the configuration result to the Tx UE.

In operation 406a: the Tx UE transmits the configuration result to the Rx UE.

The preferred embodiments of the disclosure have been described in detail above with reference to the accompanying drawings, but the disclosure is not limited to the specific details in the above embodiments. Within the technical concept of the disclosure, many simple modifications can be made to the technical solutions of the disclosure, and these simple modifications all belong to the scope of protection of the disclosure. For example, the specific technical features described in the above specific embodiments may be combined in any suitable manner without contradiction. The disclosure will not describe various possible combinations otherwise to avoid unnecessary repetition. For another example, as long as they do not contradict the idea of the disclosure, the various different embodiments of the disclosure may also be combined arbitrarily, which should also be considered as the content disclosed by the disclosure. For another example, provided that there is no conflict, the embodiments and/or technical features within the embodiments described in the disclosure may be arbitrarily combined with related art. The technical solutions obtained after the combination should also fall into the scope of protection of the disclosure.

It should also be understood that in the method embodiments of the disclosure, the size of the sequence numbers of the processes described above does not imply the sequence of execution. The sequence of execution of the processes should be determined based on their functions and inherent logics, and should not constitute any limitation on the implementation of the embodiments of the disclosure. Further, in embodiments of the disclosure, the terms “downlink”, “uplink” and “sidelink” indicates the transmission direction of signals or data. The “downlink” indicates that the transmission direction of signals or data is a first direction transmitting from the site to the user equipment of the cell, the “uplink” indicates that the transmission direction of represent signals or data is a second direction transmitting from the user equipment of the cell to the site, and the “sidelink” indicates that the transmission direction of signals or data is a third direction transmitting from the user equipment I to the user equipment 2. For example, the “downlink signal” indicates that the transmission direction of the signal is the first direction. In addition, in embodiments of the disclosure, the term “and/or”, is merely an association relationship that describes associated objects, indicating that there are three relationships. Specifically, A and/or B indicate three situations: A alone, or A and B at the same time, or B alone. In addition, the character “/” herein generally indicates that the related objects before and after the character is in a kind of “or” relationship.

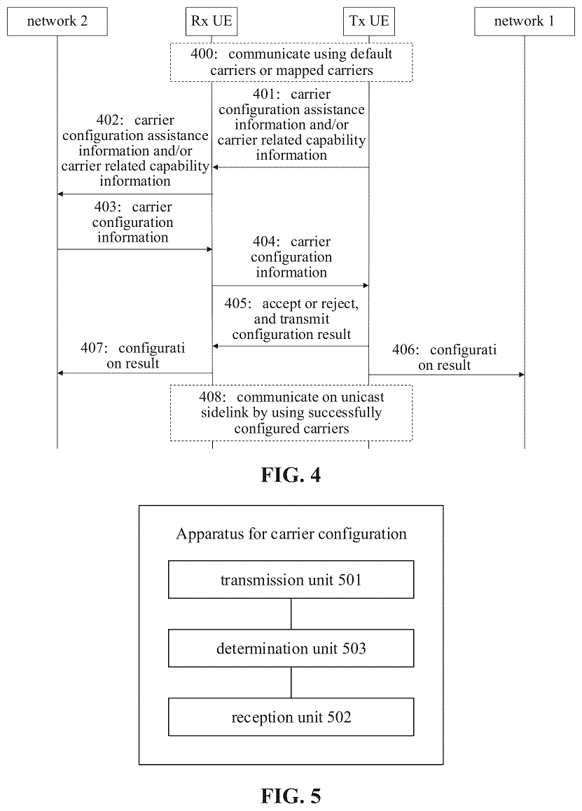

FIG. 5 is a first schematic diagram of the compositional structure of an apparatus for carrier configuration provided in an embodiment of the disclosure, and the apparatus is applied to the first terminal device. As shown in FIG. 5, the apparatus for carrier configuration includes a transmission unit 501 and a reception unit 502.

The transmission unit 501 is configured to transmit first information to a second terminal device. The first information is used for the second terminal device or a second network where the second terminal device is located to configure carriers.

The reception unit 502 is configured to receive the first configuration information from the second terminal device. The first configuration information is used to configure a plurality of carriers, and at least part of the plurality of carriers is used for unicast SL communication between the first terminal device and the second terminal device.

In some embodiments, the first information may include a carrier or a set of carriers suggested by the first terminal device for configuration and/or a carrier or a set of carriers supported by a capability of the first terminal device.

In some embodiments, the carrier or the set of carriers suggested by the first terminal device for configuration may be determined based on at least one of:
a carrier or a set of carriers supported by the capability of the first terminal device.
a carrier or a set of carriers used by the first terminal device;
a carrier or a set of carriers available to the first terminal device;
a carrier or a set of carriers supported by a capability of the second terminal device;
a carrier or a set of carriers used by the second terminal device;
a carrier or a set of carriers available to the second terminal device;
communication information of the unicast sidelink communication between the first terminal device and the second terminal device;
a link quality of a unicast sidelink between the first terminal device and the second terminal device;
a network configuration of a first network where the first terminal device is located, the network configuration of the first network is used to configure a carrier or a set of carriers supported by one or more coverage ranges of the first network; or
a network capability of a first network where the first terminal device is located, the network capability of the first network is used to determine whether the first network supports carrier aggregation.

In some embodiments, the carrier or the set of carriers supported by the capability of the first terminal device may be determined based on at least one of:
a carrier or a set of carriers used by the first terminal device;
a carrier or a set of carriers available to the first terminal device; or
a network capability of a first network where the first terminal device is located, the network capability of the first network is used to determine whether the first network supports carrier aggregation.

In some embodiments, the transmission unit 501 is configured to transmit the first information to the second terminal device in response to a trigger condition being determined to be satisfied.

In some embodiments, the trigger condition may include at least one of:
a first trigger condition including that the first terminal device receives request information from the second terminal device and the request information is used to request the first terminal device to transmit the first information to the second terminal device;
a second trigger condition including that the first terminal device receives first indication information from the second terminal device and the first indication information is used to indicate that the second terminal device and/or a second network where the second terminal device is located supports sidelink carrier aggregation;
a third trigger condition including that the first terminal device determines that a periodic time point has arrived; or
a fourth trigger condition including that the first terminal device determines that a target event has occurred.

In some embodiments, the target event may include at least one of the followings:
the carrier or the set of carriers suggested by the first terminal device for configuration is changed;
the unicast sidelink is established between the first terminal device and the second terminal device;
the carrier or the set of carriers used by the first terminal device is changed;
the carrier or the set of carriers available to the first terminal device is changed;
the link quality of the unicast sidelink between the first terminal device and the second terminal device is changed; or
a conflict occurs in a carrier resource on the unicast sidelink between the first terminal device and the second terminal device.

In some embodiments, when the first information is used for the second network where the second terminal device is located to configure carriers, the first information may be forwarded by the second terminal device to the second network. The reception unit 502 is configured to receive the first configuration information forwarded by the second terminal device from the second network.

In some embodiments, the apparatus may further include a determination unit 503. The determination unit 503 is configured to accept or reject all or part of the plurality of carriers configured by the first configuration information. The transmission unit 501 is configured to transmit a configuration result corresponding to the first configuration information to the second terminal device. The configuration result includes at least one of the followings:
second indication information used for indicating acceptance or rejection of all or part of the plurality of carriers configured by the first configuration information;
first carrier information used for indicating accepted carriers; or
second carrier information used for indicating rejected carriers.

In some embodiments, the transmission unit 501 is configured to transmit the configuration result to the first network where the transmission unit 501 is located.

In some embodiments, the transmission unit 501 is configured to transmit the first configuration information to the first network where the transmission unit 501 is located. The reception unit 502 is configured to receive a configuration result corresponding to the first configuration information from the first network. The configuration result may include at least one of the followings:
second indication information used for indicating acceptance or rejection of all or part of the plurality of carriers configured by the first configuration information;
first carrier information used for indicating accepted carriers; or
second carrier information used for indicating rejected carriers.

In some embodiments, the transmission unit 501 is configured to transmit the configuration result to the second terminal device.

In some embodiments, in the case that the second indication information is used for indicating acceptance of all or part of the plurality of carriers configured by the first configuration information, the accepted carriers indicated by the first carrier information are used for the unicast sidelink communication between the first terminal device and the second terminal device. Alternatively, in the case that the second indication information is used for indicating rejection of part of the plurality of carriers configured by the first configuration information, carriers other than the rejected carrier indicated by the second carrier information among all of the plurality of carriers configured by the first configuration information are used for the unicast sidelink communication between the first terminal device and the second terminal device.

In some embodiments, before all or part of the plurality of carriers configured by the first configuration information is successfully configured, the first terminal device and the second terminal device may communicate by using a first carrier or a second carrier. The first carrier is a default carrier or a carrier in a default set of available carriers or a carrier determined based on a first mapping rule, and the second carrier is a carrier that has been successfully configured before the first terminal device receives the first configuration information.

In some embodiments, in response to all or part of the plurality of carriers configured by the first configuration information being failed to be configured, the first terminal device and the second terminal device may communicate by using a first carrier or a second carrier or a third carrier. The first carrier is a default carrier or a carrier in a default set of available carriers or a carrier determined based on a first mapping rule, the second carrier is a carrier that has been successfully configured before the first terminal device receives the first configuration information, and the third carrier is a carrier in part of successfully configured carriers among the plurality of carriers.

In some embodiments, the first mapping rule may include a mapping relationship between third information and available carriers and/or available carrier numbers. The third information may include at least one of:
a layer 2 ID(s) of the first terminal device and/or the second terminal device;
a Tx profile corresponding to data transmission between the first terminal device and the second terminal device;
a service type or application type corresponding to data transmission between the first terminal device and the second terminal device;
a data volume corresponding to data transmission between the first terminal device and the second terminal device;
a transmission type corresponding to data transmission between the first terminal device and the second terminal device;
a QoS flow corresponding to data transmission between the first terminal device and the second terminal device;
a logical channel corresponding to data transmission between the first terminal device and the second terminal device;
a resource pool corresponding to data transmission between the first terminal device and the second terminal device;
a radio bearer corresponding to data transmission between the first terminal device and the second terminal device;
a data priority corresponding to data transmission between the first terminal device and the second terminal device; or
a channel busy rate of the resource pool corresponding to data transmission between the first terminal device and the second terminal device.

In some embodiments, the first terminal device may be a transmitting terminal of the unicast sidelink communication, and the second terminal device may be a receiving terminal of the unicast sidelink communication. Alternatively, the first terminal device may be a receiving terminal of the unicast sidelink communication, and the second terminal device may be a transmitting terminal of the unicast sidelink communication.

It should be understood by those skilled in the art that the related description of the apparatus for carrier configuration described above in embodiments of the disclosure may be understood with reference to the related description of the method for carrier configuration in embodiments of the disclosure.

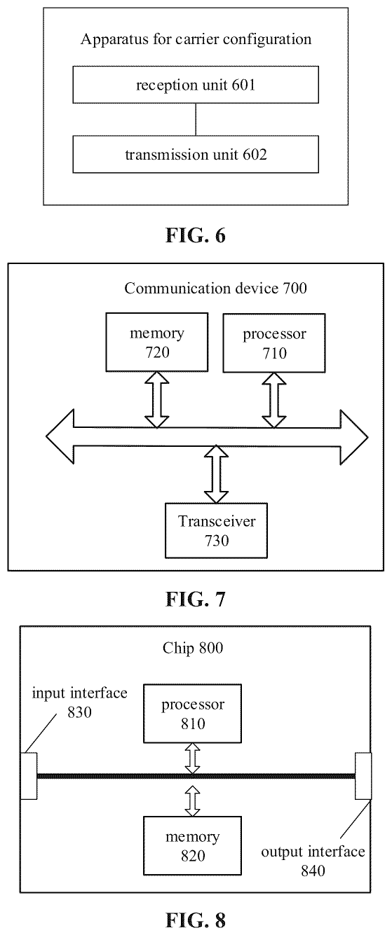

FIG. 6 is a second schematic diagram of the compositional structure of an apparatus for carrier configuration provided in an embodiment of the disclosure, and the apparatus is applied to the second terminal device. As shown in FIG. 6, the apparatus for carrier configuration includes a reception unit 601 and a transmission unit 602.

The reception unit 601 is configured to receive first information from a first terminal device. The first information is used for the second terminal device or a second network where the second terminal device is located to configure carriers.

The transmission unit 602 is configured to transmit the first configuration information to the first terminal device. The first configuration information is used to configure a plurality of carriers, and at least part of the plurality of carriers is used for unicast SL communication between the first terminal device and the second terminal device.

In some embodiments, the first information may include a carrier or a set of [00359] carriers suggested by the first terminal device for configuration and/or a carrier or a set of carriers supported by a capability of the first terminal device.

In some embodiments, the carrier or the set of carriers suggested by the first terminal device for configuration may be determined based on at least one of:
a carrier or a set of carriers supported by the capability of the first terminal device;
a carrier or a set of carriers used by the first terminal device;
a carrier or a set of carriers available to the first terminal device;
a carrier or a set of carriers supported by a capability of the second terminal device;
a carrier or a set of carriers used by the second terminal device;
a carrier or a set of carriers available to the second terminal device;
communication information of the unicast sidelink communication between the first terminal device and the second terminal device;
a link quality of a unicast sidelink between the first terminal device and the second terminal device;
a network configuration of a first network where the first terminal device is located, the network configuration of the first network is used to configure a carrier or a set of carriers supported by one or more coverage ranges of the first network; or
a network capability of a first network where the first terminal device is located, the network capability of the first network is used to determine whether the first network supports carrier aggregation.

In some embodiments, the carrier or the set of carriers supported by the capability of the first terminal device may be determined based on at least one of:
a carrier or a set of carriers used by the first terminal device;
a carrier or a set of carriers available to the first terminal device; or
a network capability of the first network where the first terminal device is located, the network capability of the first network is used to determine whether the first network supports carrier aggregation.

In some embodiments, when the first information is used for the second network where the second terminal device is located to configure carriers, the transmission unit 602 is configured to forward the first information to the second network. The reception unit 601 is configured to receive the first configuration information from the second network.

In some embodiments, the reception unit 601 is configured to receive a configuration result corresponding to the first configuration information from the first terminal device. The configuration result may include at least one of the followings:
second indication information used for indicating acceptance or rejection of all or part of the plurality of carriers configured by the first configuration information;
All or part of the carriers.
first carrier information used for indicating accepted carriers; or
second carrier information used for indicating rejected carriers.

In some embodiments, the transmission unit 602 is configured to transmit the configuration result to the second network where the transmission unit 602 is located.

In some embodiments, the apparatus may further include a processing unit. The processing unit is configured to, in response to the second indication information being used for indicating rejection of all or part of the plurality of carriers configured by the first configuration information, perform at least one of the following operations:
reconfiguring a plurality of carriers based on the first information, and transmitting the first configuration information to the first terminal device, the first configuration information being used to reconfigure the plurality of carriers;
triggering a link failure procedure of the unicast sidelink; or
disconnecting the unicast sidelink.

In some embodiments, in the case that the second indication information is used for indicating acceptance of all or part of the plurality of carriers configured by the first configuration information, the accepted carriers indicated by the first carrier information are used for the unicast sidelink communication between the first terminal device and the second terminal device. Alternatively, in the case that the second indication information is used for indicating rejection of part of the plurality of carriers configured by the first configuration information, carriers other than the rejected carrier indicated by the second carrier information among all of the plurality of carriers configured by the first configuration information are used for the unicast sidelink communication between the first terminal device and the second terminal device.

In some embodiments, before all or part of the plurality of carriers configured by the first configuration information is successfully configured, the second terminal device and the first terminal device may communicate by using a first carrier or a second carrier. The first carrier is a default carrier or a carrier in a default set of available carriers or a carrier determined based on a first mapping rule, and the second carrier is a carrier that has been successfully configured before the first terminal device receives the first configuration information.

In some embodiments, in response to all or part of the plurality of carriers configured by the first configuration information being failed to be configured, the second terminal device and the first terminal device may communicate by using a first carrier or a second carrier or a third carrier. The first carrier is a default carrier or a carrier in a default set of available carriers or a carrier determined based on a first mapping rule, the second carrier is a carrier that has been successfully configured before the first terminal device receives the first configuration information, and the third carrier is a carrier in part of successfully configured carriers among the plurality of carriers.

In some embodiments, the first mapping rule may include a mapping relationship between third information and available carriers and/or available carrier numbers. The third information may include at least one of:
a layer 2 ID(s) of the first terminal device and/or the second terminal device;
a Tx profile corresponding to data transmission between the first terminal device and the second terminal device;
a service type or application type corresponding to data transmission between the first terminal device and the second terminal device;
a data volume corresponding to data transmission between the first terminal device and the second terminal device;
a transmission type corresponding to data transmission between the first terminal device and the second terminal device;
a QoS flow corresponding to data transmission between the first terminal device and the second terminal device;
a logical channel corresponding to data transmission between the first terminal device and the second terminal device;
a resource pool corresponding to data transmission between the first terminal device and the second terminal device;
a radio bearer corresponding to data transmission between the first terminal device and the second terminal device;
a data priority corresponding to data transmission between the first terminal device and the second terminal device; or
a channel busy rate of the resource pool corresponding to data transmission between the first terminal device and the second terminal device.

In some embodiments, the first terminal device may be a transmitting terminal of the unicast sidelink communication, and the second terminal device may be a receiving terminal of the unicast sidelink communication. Alternatively, the first terminal device may be a receiving terminal of the unicast sidelink communication, and the second terminal device may be a transmitting terminal of the unicast sidelink communication.

It should be understood by those skilled in the art that the related description of the apparatus for carrier configuration described above in embodiments of the disclosure may be understood with reference to the related description of the method for carrier configuration in embodiments of the disclosure.

FIG. 7 is a schematic structural diagram of a communication device 700 provided in an embodiment of the disclosure. The communication device may be a first terminal device or a second terminal device. The communication device 700 shown in FIG. 7 includes a processor 710 that may invoke and execute a computer program from a memory to implement the method in the embodiments of the disclosure.

In an example, as shown in FIG. 7, the communication device 700 may further include a memory 720. The processor 710 may invoke and execute a computer program from the memory 720 to implement the method in the embodiments of the disclosure.

The memory 720 may be a separate component independent of the processor 710, or may be integrated in the processor 710.

In an example, as shown in FIG. 7, the communication device 700 may further include a transceiver 730, and the processor 710 may control the transceiver 730 to communicate with other devices. Specifically, the transceiver 730 may transmit information or data to other devices, or receive information or data from other devices.

The transceiver 730 may include a transmitter and a receiver. The transceiver 730 may further include antennas, and the number of antennas may be one or more than one.

In an example, the communication device 700 may be the first terminal device in the embodiments of the disclosure, and the communication device 700 may implement corresponding processes implemented by the first terminal device in methods in the embodiments of the disclosure, which will not be repeated herein for the sake of simplicity.

In an example, the communication device 700 may be the second terminal device [00409] in the embodiments of the disclosure, and the communication device 700 may implement corresponding processes implemented by the second terminal device in methods in the embodiments of the disclosure, which will not be repeated herein for the sake of simplicity.

FIG. 8 is a schematic structural diagram of a chip in an embodiment of the [00410] disclosure. The chip 800 shown in FIG. 8 includes a processor 810 that may invoke and execute a computer program from a memory to implement the method in the embodiments of the disclosure.

In an example, as shown in FIG. 8, the chip 800 may further include a memory 820. The processor 810 may invoke and execute a computer program from the memory 820 to implement the method in the embodiments of the disclosure.

The memory 820 may be a separate device independent of the processor 810, or may be integrated in the processor 810.

In an example, the chip 800 may further include an input interface 830. The processor 810 may control the input interface 830 to communicate with other devices or chips. Specifically, the input interface 830 may acquire information or data from other devices or chips.

In an example, the chip 800 may further include an output interface 840. The processor 810 may control the output interface 840 to communicate with other devices or chips. Specifically, the output interface 840 may output information or data to other devices or chips.

In an example, the chip 800 may be applied to the first terminal device in the embodiments of the disclosure, and the chip 800 may implement corresponding processes implemented by the first terminal device in methods in the embodiments of the disclosure, which will not be repeated herein for the sake of simplicity.

In an example, the chip 800 may be applied to the second terminal device in the embodiments of the disclosure, and the chip 800 may implement corresponding processes implemented by the second terminal device in methods in the embodiments of the disclosure, which will not be repeated herein for the sake of simplicity.

It should be understood that the chip mentioned in the embodiments of the disclosure may also be referred to as a system-level chip, system chip, chip system, or system on chip.

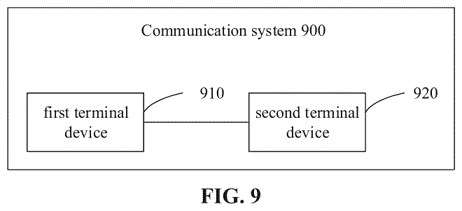

FIG. 9 is a schematic block diagram of a communication system 900 provided in an embodiment of the disclosure. As shown in FIG. 9, the communication system 900 includes a first terminal device 910 and a second terminal device 920.

The first terminal device 910 may be used to implement the corresponding functions implemented by the first terminal device in the above method, and the second terminal device 920 may be used to implement the corresponding functions implemented by the second terminal device in the above method, which will not be repeated herein for the sake of simplicity.

It should be understood that the processor in the embodiment of the disclosure may be an integrated circuit chip with a signal processing capability. In implementation, the operations of the above method embodiments may be accomplished by an integrated logic circuit of the hardware in the processor or the instructions in the form of software. The processor described above may be a general-purpose processor, a Digital Signal Processor (DSP), an Application Specific Integrated Circuit (ASIC), a Field Programmable Gate Array (FPGA) or other programmable logic devices, a discrete gate or transistor logic device, or a discrete hardware component. The methods, operations and logic block diagrams disclosed in embodiments of the disclosure may be implemented or performed. The general-purpose processor may be a microprocessor, or may be any conventional processor or the like. The operations of the methods disclosed combined with embodiments of the disclosure may be directly embodied as execution of a hardware decoding processor or execution of a combination of a hardware module and a software module in the decoding processor. The software module may be located in a storage medium mature in the art, such as a random access memory, a flash memory, a read-only memory, a programmable read-only memory, or an electrically crasable and programmable memory, a register, etc. The storage medium is located in the memory, and the processor reads information in the memory and completes the operations of the method described above in combination with its hardware.

It is understood that in the embodiments of the disclosure, the memory may be a volatile memory or a non-volatile memory, or include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), which serves as an external cache. By way of illustration, but not limitation, many forms of RAM are available, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchronous link DRAM (SLDRAM) and a Direct Rambus RAM (DRRAM). It should be noted that the memory of the systems and methods described herein is intended to include but not limited to these and any other suitable types of memories.

It should be understood that the above memory is an illustrative but not limiting illustration. For example, the memory in the embodiments of the disclosure may also be a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch link DRAM (SLDRAM) and a Direct Rambus RAM (DRRAM), etc. That is to say, the memory in the embodiments of the disclosure is intended to include but not limited to these and any other suitable types of memories.

In an embodiment of the disclosure, a computer-readable storage medium having stored thereon a computer program is further provided.

In an example, the computer-readable storage medium may be applied to the first terminal device in the embodiments of the disclosure, and the computer-readable storage medium may cause a computer to execute corresponding processes implemented by the first terminal device in the methods in the embodiments of the disclosure, which will not be repeated herein for the sake of simplicity.

In an example, the computer-readable storage medium may be applied to the second terminal device in the embodiments of the disclosure, and the computer-readable storage medium may cause a computer to execute corresponding processes implemented by the second terminal device in methods in the embodiments of the disclosure, which will not be repeated herein for the sake of simplicity.

In an embodiment of the disclosure, a computer program product having stored therein computer program instructions is further provided.

In an example, the computer program product may be applied to the first terminal device in the embodiments of the disclosure, and the computer program instructions may cause a computer to execute corresponding processes implemented by the first terminal device in the methods in the embodiments of the disclosure, which will not be repeated herein for the sake of simplicity.

In an example, the computer program product may be applied to the second terminal device in the embodiments of the disclosure, and the computer program instructions may cause a computer to execute corresponding processes implemented by the second terminal device in the methods in the embodiments of the disclosure, which will not be repeated herein for the sake of simplicity.

In an embodiment of the disclosure, a computer program is further provided.

In an example, the computer program may be applied to the first terminal device in the embodiments of the disclosure. The computer program that, when executed by a computer, may cause a computer to execute corresponding processes implemented by the first terminal device in the methods in the embodiments of the disclosure, which will not be repeated herein for the sake of simplicity.

In an example, the computer program may be applied to the second terminal device in the embodiments of the disclosure. The computer program that, when executed by a computer, may cause a computer to execute corresponding processes implemented by the second terminal device in the methods in the embodiments of the disclosure, which will not be repeated herein for the sake of simplicity.

Those of ordinary skilled in the art will appreciate that the units and algorithmic operations of the examples described in connection with the embodiments disclosed herein may be implemented in electronic hardware, or a combination of computer software and electronic hardware. Whether these functions are performed in hardware or software depends on the specific application and design constraints of the technical solutions. The professionals may use different methods to implement the described functions for each particular application, and such implementations should not be considered beyond the scope of the disclosure.

Those skilled in the art may clearly understand that the specific working processes of the systems, devices, and units described above may refer to the corresponding processes in the above method embodiments, which will not be repeated herein for convenience and conciseness of the description.

In several embodiments provided in the disclosure, it should be understood that the described systems, devices, and methods may be implemented in other ways. For example, the device embodiments described above are only schematic. For example, the partition of the unit is only a logical functional partition, which may be implemented in another partition way in practice. For example, the multiple units or components may be combined or integrated into another system, or some features may be omitted or not implemented. On the other hand, the shown or discussed coupling or direct coupling or communication connection between each other may be indirect coupling or communication connection through some interfaces, devices or units, and may be electrical, mechanical or other forms.

The units described as separate components may or may not be physically separate, and the components displayed as units may or may not be physical units, that is, they may be located in one place or be distributed to multiple network units. Part or all of the units may be selected based on the actual needs to achieve the purpose of the solution of the embodiment.

In addition, the functional units in the embodiments of the disclosure may be integrated into one processing unit, or they may be physically exist separately as individual units, or two or more units may be integrated into one unit.

The functions may be stored in a computer readable storage medium if implemented in the form of software functional units and sold or used as a stand-alone product. Based on this understanding, technical solutions of the disclosure in nature or the part of the technical solutions that contributes to the related art or the part of the technical solutions may be embodied in the form of a software product stored in a storage medium. The storage medium includes instructions which causes a computer device (which may be a personal computer, a server, or a network device, etc.) to execute all or part of the operations in the methods described in embodiments of the disclosure. The above-mentioned storage medium includes various media capable of storing program codes, such as U disk, mobile hard disk, Read-Only Memory (ROM), Random Access Memory (RAM), magnetic disk or optical disk.

The above description is only the specific embodiments of the disclosure; however, the scope of protection of the disclosure is not limited thereto. Any change or replacement obvious to the skilled person familiar with the technical field within the technical scope disclosed by the disclosure shall be covered within the scope of protection of the disclosure. Therefore, the scope of protection of the disclosure should be subject to the scope of protection of the claims.

1. A method for carrier configuration, comprising:
transmitting, by a first terminal device, first information to a second terminal device, wherein the first information is used for the second terminal device or a second network where the second terminal device is located to configure carriers; and
receiving, by the first terminal device, first configuration information from the second terminal device, wherein the first configuration information is used for configuring a plurality of carriers, and at least part of the plurality of carriers are used for unicast sidelink communication between the first terminal device and the second terminal device.

2. The method of claim 1, wherein the first information comprises a carrier or a set of carriers supported by a capability of the first terminal device.

3. The method of claim 2, wherein the carrier or the set of carriers supported by the capability of the first terminal device is determined based on at least one of:
a carrier or a set of carriers used by the first terminal device;
a carrier or a set of carriers capable for the first terminal device; or
a network capability of a first network where the first terminal device is located, wherein the network capability of the first network is used to determine whether the first network supports carrier aggregation.

4. The method of claim 1, wherein transmitting, by the first terminal device, the first information to the second terminal device, comprises:
transmitting, by the first terminal device, the first information to the second terminal device in response to a trigger condition being determined to be satisfied.

5. The method of claim 4, wherein the trigger condition comprises:
a first trigger condition, comprising that the first terminal device receives request information from the second terminal device and the request information is used to request the first terminal device to transmit the first information to the second terminal device.

6. The method of claim 1, wherein the first information is forwarded by the second terminal device to the second network in the case that the first information is used for the second network where the second terminal device is located to configure carriers; and
wherein receiving, by the first terminal device, the first configuration information from the second terminal device, comprises:
receiving, by the first terminal device, the first configuration information forwarded by the second terminal device from the second network.

7. The method of claim 1, after receiving by the first terminal device the first configuration information from the second terminal device, the method further comprising:
accepting or rejecting, by the first terminal device, all or part of the plurality of carriers configured by the first configuration information; and transmitting, by the first terminal device, a configuration result corresponding to the first configuration information to the second terminal device, wherein the configuration result comprises:
second indication information for indicating acceptance or rejection of all or part of the plurality of carriers configured by the first configuration information.

8. The method of claim 7, wherein
in the case that the second indication information is used for indicating acceptance of all or part of the plurality of carriers configured by the first configuration information, the accepted carriers indicated by the first carrier information are used for the unicast sidelink communication between the first terminal device and the second terminal device.

9. The method of claim 1, further comprising:
before all or part of the plurality of carriers configured by the first configuration information are successfully configured, using, by the first terminal device, a first carrier or a second carrier to communicate with the second terminal device, wherein the first carrier is a default carrier or a carrier in a default set of available carriers or a carrier determined based on a first mapping rule, and the second carrier is a carrier that has been successfully configured before the first terminal device receives the first configuration information; or
in response to all or part of the plurality of carriers configured by the first configuration information being failed to be configured, using, by the first terminal device, a first carrier or a second carrier or a third carrier to communicate with the second terminal device, wherein the first carrier is a default carrier or a carrier in a default set of available carriers or a carrier determined based on a first mapping rule, the second carrier is a carrier that has been successfully configured before the first terminal device receives the first configuration information, and the third carrier is a carrier in part of successfully configured carriers among the plurality of carriers.

10. The method of claim 1, wherein
the first terminal device is a transmitting terminal of the unicast sidelink communication, and the second terminal device is a receiving terminal of the unicast sidelink communication; or,
the first terminal device is a receiving terminal of the unicast sidelink communication, and the second terminal device is a transmitting terminal of the unicast sidelink communication.

11. A method for carrier configuration, comprising:
receiving, by a second terminal device, first information from a first terminal device, wherein the first information is used for the second terminal device or a second network where the second terminal device is located to configure carriers; and
transmitting, by the second terminal device, first configuration information to the first terminal device, wherein the first configuration information is used for configuring a plurality of carriers, and at least part of the plurality of carriers are used for unicast sidelink communication between the first terminal device and the second terminal device.

12. The method of claim 11, wherein in the case that the first information is used for the second network where the second terminal device is located to configure carriers,
the method further comprises: forwarding, by the second terminal device, the first information to the second network, after the second terminal device receives the first information from the first terminal device; and
the method further comprises: receiving, by the second terminal device, the first configuration information from the second network, before the second terminal device transmits the first configuration information to the first terminal device.

13. The method of claim 11, after transmitting, by the second terminal device, the first configuration information to the first terminal device, the method further comprising:
receiving, by the second terminal device, a configuration result corresponding to the first configuration information from the first terminal device, wherein the configuration result comprise:
second indication information for indicating acceptance or rejection of all or part of the plurality of carriers configured by the first configuration information.

14. The method of claim 13, wherein
in the case that the second indication information is used for indicating acceptance of all or part of the plurality of carriers configured by the first configuration information, the accepted carriers indicated by the first carrier information are used for the unicast sidelink communication between the first terminal device and the second terminal device.

15. The method of claim 11, further comprising:
before all or part of the plurality of carriers configured by the first configuration information are successfully configured, communicating by using, by the second terminal device, a first carrier or a second carrier to communicate with the first terminal device, wherein the first carrier is a default carrier or a carrier in a default set of available carriers or a carrier determined based on a first mapping rule, and the second carrier is a carrier that has been successfully configured before the first terminal device receives the first configuration information; or
in response to all or part of the plurality of carriers configured by the first configuration information being failed to be configured, using, by the second terminal device, a first carrier or a second carrier or a third carrier to communicate with the first terminal device, wherein the first carrier is a default carrier or a carrier in a default set of available carriers or a carrier determined based on a first mapping rule, the second carrier is a carrier that has been successfully configured before the first terminal device receives the first configuration information, and the third carrier is a carrier in part of successfully configured carriers among the plurality of carriers.

16. An apparatus for carrier configuration, applied to a first terminal device, the apparatus comprising:
a transmitter, configured to transmit first information to a second terminal device, wherein the first information is used for the second terminal device or a second network where the second terminal device is located to configure carriers; and
a receiver, configured to receive first configuration information from the second terminal device, wherein the first configuration information is used for configuring a plurality of carriers, and at least part of the plurality of carriers are used for unicast sidelink communication between the first terminal device and the second terminal device.

17. The apparatus of claim 16, wherein the transmitter is configured to transmit the first information to the second terminal device in response to a trigger condition being determined to be satisfied.

18. The apparatus of claim 17, wherein the trigger condition comprises:
a first trigger condition, comprising that the first terminal device receives request information from the second terminal device and the request information is used to request the first terminal device to transmit the first information to the second terminal device.

19. An apparatus for carrier configuration, applied to a second terminal device, the apparatus comprising: a processor, a transmitter and a receiver,
wherein the processor is configured to control the receiver and the transmitter to implement operations of the method of claim 11.

20. The apparatus of claim 19, wherein after the transmitter transmits the first configuration information to the first terminal device, the receiver is further configured to:
receive a configuration result corresponding to the first configuration information from the first terminal device,
wherein the configuration result comprise: second indication information for indicating acceptance or rejection of all or part of the plurality of carriers configured by the first configuration information.
